(19) United States
(12) Patent Application Publication
(10) Pub. No.: US 2007/0192734 A1
(43) Pub. Date: Aug. 16, 2007

(54) Methods and arrangements to control pop-up windows

(76) Inventors: Viktors Berstis, Austin, TX (US); Randolph M. Forlenza, Austin, TX (US); John P. Kaemmerer, Pflugerville, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/355,696

(22) Filed: Feb. 16, 2006

(51) Int. Cl. G06F 3/00

(52) U.S. Cl. 715/808

(57) ABSTRACT

Methods and arrangements to control pop-up windows are contemplated. Embodiments include transformations, code, state machines or other logic to deny focus to a pop-up window that is generated within a pop-up delay interval of input activity on the part of a user. In some embodiments, the pop-up delay interval may be a default value such as ten seconds. In other embodiments, the pop-up delay interval is configurable. In some embodiments, the pop-up window may be granted focus after the user ceases input activity for the pop-up delay interval. In some embodiments, the pop-up window may be displayed without focus. Some of these embodiments may modify the region of the screen in which the pop-up window is displayed. In some embodiments, the pop-up window may be displayed in a portion of the screen that does not overlap with the portion of the window that does have focus. In some embodiments, the user may be notified that a pop-up window was displayed without focus. In some embodiments, the user may disable the denial of focus to pop-up windows. In some embodiments, the user may exempt classes of pop-up windows from the denial of focus.

### FIELD

The present invention is in the field of the computer display windows. More particularly, the present invention relates to methods and arrangements to control pop-up windows.

### BACKGROUND

Pop-up windows are windows that are displayed without the request of a user. There are many sources of pop-up windows. For example, visiting or leaving a web page may cause the generation of a pop-up window. Many applications generate pop-up windows. For example, instant message applications generate pop-up windows to notify a user of the receipt of a message. Other pop-up windows may serve to warn a user of errors or potential problems, such as an almost-exhausted battery powering the computer or a severe shortage of RAM for an application. Some pop-up windows may explain the use of a program. When the user begins to use a feature of a program, such as generating a new invoice in an accounting program, a pop-up window may explain how to proceed.

Pop-up windows generated while a user is interacting with a computer may obtain focus; that is, the user input from the keyboard is directed to the pop-up window. This transferring of focus may prove a nuisance or even a safety hazard and may lead to the exposure of confidential material. For example, an assistant to a word-processing program which appeared automatically and stole focus is widely considered one of the most annoying features ever seen on a computer. The pop-up windows which seize focus may interfere with the input of data. A user who continues typing without changing the focus back to the window in which the user was entering data has the input directed to the wrong window. Inappropriate results may occur. For example, a user may enter an incorrect command into an application, because some of the characters of the command were transmitted to the wrong window. The seizing of focus by pop-up windows may lead to the exposure of confidential data. A user unaware of the generation of an instant message window may continue typing confidential data, causing the data to be directed to the instant message window. The user may then hit ENTER, causing the data to be sent by instant message to the sender of the message. To continue entering data to a desired application when a stream of pop-up windows is generated, a user may have to repeatedly click on a window for the application to regain focus for the window. This monitoring of the pop-ups and constant clicking may distract a user from concentrating on a current task. The distraction may prove a hazard if the current task involves urgent system maintenance or another critical function. The user may be performing real-time programming to maintain a system or may be involved in a critical conference call through the computer.

Web browsers may provide pop-up blockers. These blockers may, however, block only pop-up windows generated through use of the browser. They may not block pop-up windows generated by non web-based applications, such as instant messaging. Further, the blocking may provide a completely inflexible form of control of pop-up windows. The only form of control may consist of blocking, rather than a less disruptive modification of the display of pop-up windows. Because the pop-up windows are completely blocked, a user may receive no information about the windows that were blocked. Further, the pop-up blockers provided by web-browsers may block all pop-up windows, regardless of type. They may not permit a user to select which types of pop-up windows are blocked. The browser pop-up blockers may also have difficulty distinguishing between genuine pop-up windows and user-initiated windows.

Pop-up windows may utilize features provided by an operating system for creating windows, setting their properties, and managing them. An operating system application programming interface (API) may implement functions related to the display and behavior of windows. Calls using functions implemented in the API may enable the generation of a window with a particular display in a particular region of the screen and may grant focus to the window. The Windows API, for example, implements the CreateWindow function. A call to the function creates a window of a class, title and style. Optionally, the initial position and size of the window may be specified. The Windows API also implements the function SetFocus, which sets the keyboard focus to the specified window. In addition to managing windows, an operating system may monitor mouse or keyboard input and communicate it to the appropriate window in the form of messages posted to the window by the operating system. The operating system may communicate the keyboard input to the window with focus in the form of messages and may communicate information about mouse activity to the window in which the user is clicking or pointing the mouse.

### SUMMARY OF THE INVENTION

The problems identified above are in large part addressed by methods and arrangements to control pop-up windows. One embodiment provides a method to control pop-up windows. The method may involve determining a pop-up delay interval. The method may also involve receiving a request to grant focus to a pop-up window. The method may further involve detecting input from a user within the pop-up delay interval and denying the request to grant focus in response to detecting user input within the pop-up delay interval.

Another embodiment provides an apparatus to control pop-up windows. The apparatus may comprise a pop-up interface to detect input from a user through an input device within a pop-up delay interval. The apparatus may further comprise a pop-up displayer to deny a request to grant focus to a pop-up window upon detection of the input.

Another embodiment provides machine-accessible medium containing instructions to control pop-up windows, which when the instructions are executed by a machine, cause said machine to perform operations. The operations may involve determining a pop-up delay interval. The operations may also involve receiving a request to grant focus to a pop-up window. The operations may further involve detecting input from a user within the pop-up delay interval and denying the request to grant focus in response to detecting user input within the pop-up delay interval.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a computer containing an operating system configured to control pop-up windows;

FIG. 2 depicts an embodiment of a pop-up controller;

FIG. 3 depicts an embodiment that modifies the region of display of a pop-up window;

FIG. 4 depicts an example diagram of applications which are requesting focus for newly-created windows; and

FIG. 5 depicts a flowchart of an embodiment to control pop-up windows.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to control pop-up windows are contemplated. Embodiments include transformations, code, state machines or other logic to deny focus to a pop-up window that is generated within a pop-up delay interval of input activity on the part of a user. In some embodiments, the pop-up delay interval may be a default value such as ten seconds. In other embodiments, the pop-up delay interval is configurable. In further embodiments, the pop-up window may be granted focus after the user ceases input activity for the pop-up delay interval. In several embodiments, the pop-up window may be displayed without focus. Some of these embodiments may modify the region of the screen in which the pop-up window is displayed. In many embodiments, the pop-up window may be displayed in a portion of the screen that does not overlap with the portion of the window that does have focus. In some embodiments, the user may be notified that a pop-up window was displayed without focus. Embodiments may also allow the user to disable the denial of focus to pop-up windows. In some embodiments, the user may exempt classes of pop-up windows from the denial of focus.

While specific embodiments will be described below with reference to particular circuit or logic configurations, those of skill in the art will realize that embodiments of the present invention may advantageously be implemented with other substantially equivalent configurations.

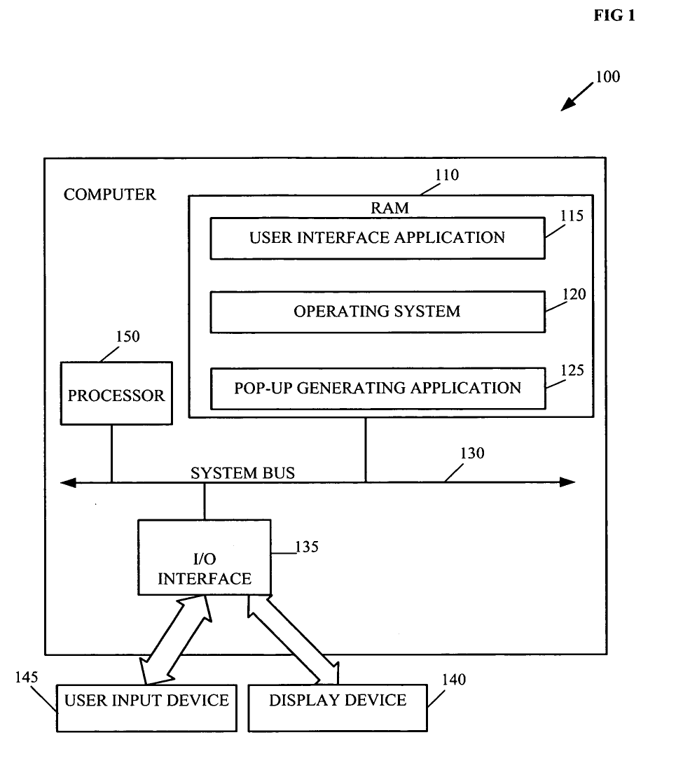

FIG. 1 depicts an embodiment of a computer 100 with a user input device 145 such as a mouse or keyboard and a display device 140 such as a monitor. For the present embodiment, user input includes both keyboard and mouse activity. Further embodiments may include other forms of user input such as voice commands, bar code scanners, text scanners, tablets, touch screens, and/or other forms of user input.

Computer 100 includes random access memory (RAM) 110, an input/output (I/O) interface 135 and a processor 150 or CPU connected by system bus 130. I/O interface adapter 135 implements user-oriented I/O through, for example, software drivers and computer hardware for controlling output to display devices such as display device 140 as well as user input from user input device 145. One type of software driver, a keyboard device driver, may interpret signals sent by a keyboard and translate them into values understandable by an operating system 120 that identify the purpose of a key. After translating a keyboard signal, the keyboard device driver may store information about the signal in a buffer, create a message with information about the keystroke, and place the message in the system message queue. The operating system 120 may remove the message from the system message queue, determine the appropriate window to receive the message, and post the message to the appropriate window, the window that is receiving keyboard input (has focus). A user, for example, may set the window that receives keyboard input (set focus) by clicking on the window; by using a key combination such as ALT TAB, ALT ESC, CTL F6, or CTL N; or by using menu commands. In addition, applications may change focus by issuing calls to an operating system API. For example, in Windows, an application may issue a SetFocus call.

Similarly, user mouse activity may be translated by drivers into system messages. These messages, however, may be sent to the window to which the mouse is pointing, not necessarily to the window currently receiving keyboard input. For example, in Windows, a cursor indicates the window to which the mouse is pointing. The shape of the cursor may change when the cursor is moved from one window to another. Windows transmits information about the mouse activity to the window to which the cursor is pointing, and the application controlling the window determines the appropriate display for the cursor.

Stored in RAM 110 is a user interface application 115, an operating system 120, and a pop-up generating application 125. User interface application 115 is a computer program that accepts user input through the user interface device 145. Operating systems useful in computers according to embodiments of the present invention include UNIX™, Linux™, Microsoft Windows™, AIX™, IBM's i5/OS™, and others as will occur to those of skill in the art. Pop-up generating application 125 is a computer program that may generate pop-up windows. For example, pop-up generating application 125 may be an instant message application which generates a pop-up window whenever the current user receives an instant message. As another example, pop-up generating application 125 may alert a user about potential error conditions such as a shortage of RAM or a low battery. The pop-up window may request focus.

User interface application 115, operating system 120, and pop-up generating application 125 are shown in RAM 110 in FIG. 1, but many components of such software may be stored in non-volatile memory also. In the embodiment of FIG. 1, operating system 120 is configured to deny the grant of focus to a pop-up window which occurs within an interval of input from a user. For example, if pop-up generating application 125 generated a pop-up window while a user was entering input into user interface application 115 through user input device 145, operating system 120 may delay granting focus to the pop-up window for a certain interval after the user ceases entering the input.

In other embodiments, a pop-up controller implemented in hardware, firmware, state machines or a program separate from an operating system may control pop-up windows. The pop-up controller may monitor system message traffic about windows and user input and deny focus to pop-up windows which request the focus within an interval of input from a user. An operating system program programming interface (API) may provide a mechanism for programs to monitor messages to windows and process the messages. The Windows API, for example, provides a mechanism called hooks. A program may set a hook for a particular type of message by calling the SetWindowsHookEx function with a specified procedure and a specification of the type of message. Windows may then pass messages of the specified type to the specified procedure. The messages can include messages that a window is about to receive the keyboard focus, that the operating system is sending a message about mouse activity to a window, and that the operating system is sending a message about keyboard input to the window with focus. Through the use of hooks in Windows or similar mechanisms in other operating systems, the pop-up controller may deny focus to pop-up windows which request the focus within an interval of input from a user. The pop-up controller may receive a message requesting focus for a window, determine that the window was a pop-up window, and determine whether user input has occurred within a pop-up delay interval. If so, the pop-up controller may deny the grant of focus to the requesting pop-up window. The pop-up controller may also, for example, delay passing on the message containing the request for focus. It could also cause the pop-up window to be drawn in an area of the screen which does not overlay the window which currently does have focus (if possible).

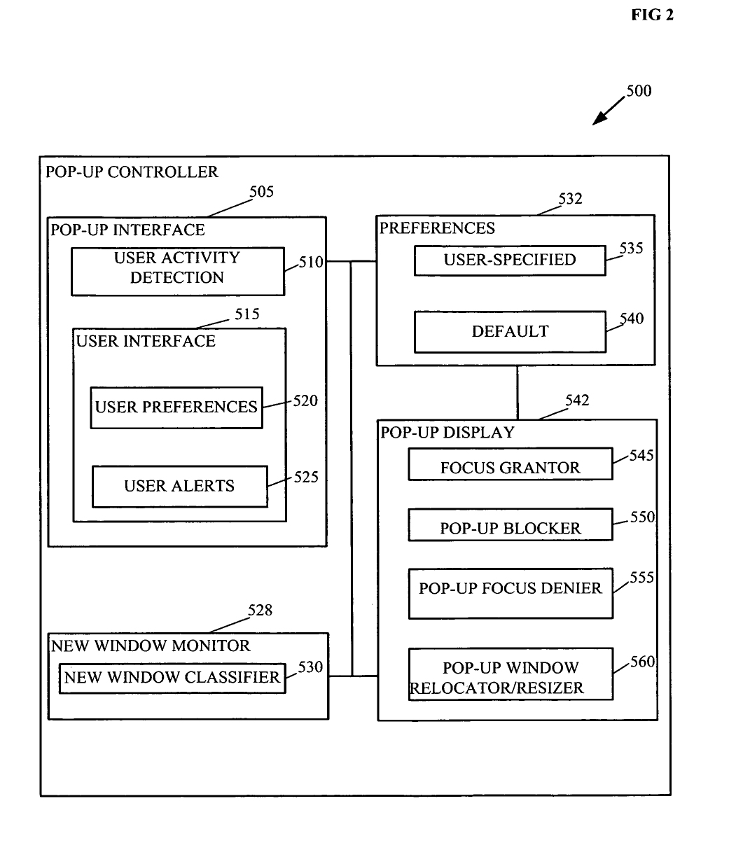

Turning to FIG. 2, depicted is an embodiment of a pop-up controller 500 that includes a pop-up interface 505, a new window monitor 528, preferences 532, and a pop-up displayer 542. Pop-up controller 500 is an apparatus to control pop-up windows. For example, new window monitor 528 may detect a message to create a new window. New window monitor 528 may classify the window as user-initiated or non-user-initiated (pop-up). If the window is a pop-up window, pop-up displayer 542 may block or modify the display of the pop-up window if there is user input within a pop-up delay interval. Pop-up displayer 542 may receive from pop-up interface 505 information on the detection of user activity. Pop-up displayer 542 may examine the preferences 532 for the display of pop-up windows in determining how, if at all, to delay or draw the pop-up window. Pop-up interface 505 may receive an indication of preferences from a user and transmit the preferences to preferences 532 for storage. Pop-up interface 505 may also detect user input and transmit the information to pop-up displayer 542. In addition, pop-up interface 505 may alert a user to the modification of the display of a pop-up window. Pop-up controller 500 may be implemented as software, either an operating system or a separate program; hardware; firmware; state machines; and other realizations.

New window monitor 528 monitors the creation of new windows. New window monitor 528 includes new window classifier 530. New window classifier 530 may classify a window as pop-up if it is not user-initiated. In some embodiments, new window classifier 530 may classify a new window as user-initiated if the thread that created the window is related to a thread controlling a window in which the user has recently entered input such as, for example, within 100 ms. Otherwise, in these embodiments, the new window classifier may classify the window as pop-up. In other embodiments, the request for the new window may include a parameter which indicates whether the window is a pop-up window. If the new window is in a thread related to the application that the user is currently involved with and the parameter indicates that the window is not a pop-up, then the new window may be classified as not a pop-up window. In still other embodiments, an application may register with the pop-up classifier 500 the user inputs that produce new windows. In many applications, for example, the key combination CTL N produces a new window. In these embodiments, the new window classifier 530 may check for registered input in the application requesting a new window.

Pop-up displayer 542 controls the display of pop-up windows. Pop-up displayer 542 includes focus grantor 545, pop-up blocker 550, pop-up focus denier 555, and pop-up window relocator/resizer 560. Pop-up displayer 542 may receive a classification of a newly created or requested window from new window monitor 528. If the new window is classified as a pop-up window, pop-up displayer 542 may determine how to display the pop-up window. If there has been no user input for a pop-up delay interval, the pop-up displayer 542 may display the pop-up window according to the message requesting its creation. If the pop-up window falls within a class specified by a user, the pop-up displayer 542 may display the pop-up window according to instructions for the specified class. The instructions for one class may indicate to display a class of windows as indicated in the messages creating the windows. The instructions for another class of pop-up windows may specify that the pop-up windows should be blocked.

Pop-up blocker 550 controls the blocking of pop-up windows. Pop-up blocker may, for example, block or intercept messages to create windows, and thereby block the windows. Pop-up focus denier 555 may display a pop-up window without granting focus. As a result, user keyboard input will continue to be directed to the window currently having focus rather than to the pop-up window. Later, when user input has ceased for the pop-up delay interval, focus grantor 545 may display the pop-up window with focus. If a series of pop-up windows have been denied focus, focus grantor 545 may grant focus to each in turn, pausing after each grant to permit the user to interact with the pop-up window. In addition, pop-up window relocator/resizer 560 may modify the region for display of the pop-up window. In some embodiments, pop-up window relocator/resizer 560 may display the pop-up window in a window disjoint from the window with focus. If the user moves the mouse over the pop-up window and another window is beneath the pop-up window, the pop-up window relocator/resizer 560 may move the pop-up window to allow the user access to the other window. In some embodiments, the pop-up window relocator/resizer 560 may display the pop-up window in a region overlapping the region with focus. In further embodiments, the pop-up window relocator/resizer 560 may relocate the pop-up window so that it does not cover up the user's current input. Pop-up displayer 542 may obtain information about how to display pop-ups, such as information about the classes of pop-up windows to receive special treatment and the length of the pop-up delay interval, from preferences 532.

Preferences 532 is a facility for storing preferences, such as the pop-up delay interval, the pause between granting focus, and the classes of pop-up windows for special treatment. Preferences 532 may be implemented in RAM, flash memory, ROM, or other forms of memory. Preferences 532 includes user-specified preferences 535 and default preferences 540. User-specified preferences are those specified by a user through the user interface 515. In some embodiments, user-specified preferences may include the pop-up delay interval, a specification of classes of pop-up windows whose display the pop-up controller 200 should not modify, and a specification of classes of pop-up windows which are to be completely blocked. In some embodiments, default preferences may include the delay before granting focus to the next in a series of pop-up windows which were denied focus.

Pop-up interface 505 handles input for the pop-up controller 500. Pop-up interface 505 includes user input detection 510 and user interface 515. User input detection 510 may monitor system messages to detect user input such as keyboard and mouse activity, voice commands, bar code scanners, text scanners, tablets, touch screens, and/or other forms of user input. User input detection 510 may monitor message traffic between the operating system and windows which informs the windows of user input. In some embodiments, user input detection 510 may consist of a component of the operating system. In other embodiments, user input detection 510 may utilize hooks or a similar mechanism to monitor message traffic about user input. User interface 515 includes user preferences 520 and user alerts 525. User preferences 520 provides an interface for entering user preferences. The preferences are stored in user-specified preferences 535. The interface may include a series of screens such as in a wizard, a drop-down menu, a combo box, a pop-up menu, a pie menu, or other forms of graphical interface. The preferences may include the pop-up delay interval and the specification of classes of pop-up windows for special treatment. In some embodiments, the user preferences 520 may have a permanent display on the screen, such as an icon on the taskbar. In these embodiments, the user may click on the display to enter or modify preferences. In alternative embodiments, the user may launch the user interface 515 to enter or modify preferences. User alerts 525 alerts the user to the modification of display of a pop-up window. In some embodiments, user alerts 525 may consist of an icon on the task bar which flashes when the pop-up controller denies focus to a pop-up window. In further embodiments, the user may click on the icon to obtain further information about the pop-up window. In alternative embodiments, the user alerts 525 may generate a sound to notify the user.

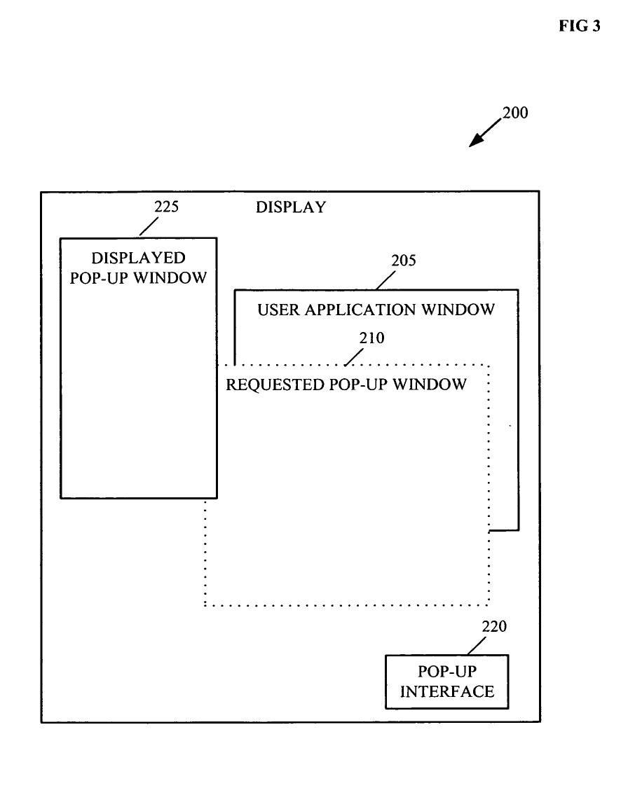

FIG. 3 depicts an embodiment that modifies the region of display of a pop-up window in display 200. Display 200 includes a window 205 generated by a user application, a requested region 210 for the display of a pop-up window, the actual region for the display of the pop-up window 225, and a pop-up interface 220. In FIG. 3, window 205 may have focus. The user may be entering input to be processed by the application associated with user application window 205. For example, the user may be entering keystrokes into a word-processing program. As another example, the user may be entering real-time commands into an interface for the control of a computer network to attempt to prevent the network from crashing or to foil hackers.

In the present embodiment, another application has requested the display of a pop-up window 210 and the grant of focus to the pop-up window 210. The embodiment may deny the grant of focus if the request occurs within an interval of time following the most recent user activity. As a result, the user's keyboard input will continue to be directed to user application window 205. In some embodiments, the request for focus may be granted after the user has ceased input for the interval.

In the present embodiment, the pop-up window is displayed without granting it focus. However, the region for the display of the pop-up window is modified. Window 210 indicates the requested region for the display of the pop-up window. The requested region, the region of window 210, overlaps the window 205 of the application to which the user is submitting input. To prevent the overlap, the region for display of the pop-up window is changed to the region of window 225, a region which is otherwise free of display.

A pop-up controller such as the operating system, a separate program, or hardware may use system commands to change, e.g., the region of the display of a pop-up window such as pop-up window 225. Under Windows, for example, the SetWindowPos function may change the size and position of a window, specify which other windows overlap the window, and specify which other windows are overlapped by the window.

Further embodiments may implement such changes for multiple pop-up windows. For instance, if a series of pop-up windows is generated while there is activity from the user, each of the windows may, in turn, be repositioned and denied the grant of focus. The repositioning of the windows and denial of focus for an interval after user activity may advantageously avoid distracting the user and may prevent sending keyboard input to an unintended destination. After the cessation of input from the user, the pop-up windows may be granted focus. The grant of focus may be in the order in which the pop-up windows were generated or may be implemented in an order based upon, e.g., priorities associated with the pop-up windows and/or applications that generated the pop-up windows. Furthermore, there may be a delay between the grant of focus to one pop-up window and the next in order to provide the user with some pre-selected or determined amount of time to read the pop-up window.

In other embodiments, the region of display of a pop-up window that is denied focus may be displayed partially or completely overlapped another window or windows. In particular, the pop-up window may be displayed overlapping the window with focus 205. In embodiments in which the pop-up window overlaps the window with focus 205, the location of the pop-up window may be shifted when the pop-up window is covering up the area of the window with focus 205 in which a user's keyboard input is being displayed. In alternative embodiments, a pop-up window may not be displayed until it is granted focus. In some embodiments, the display window 225 for a pop-up window may be moved in response to mouse activity. If, for example, a user clicks on a window to give it focus and the display window 225 overlaps the window acquiring focus, the display window 225 may be moved to a location not overlapping the window acquiring focus. Similarly, in some embodiments, if a user moves the mouse to a region where the pop-up window is displayed, the display may be moved, to enable the user to access a window overlapped by the pop-up window. Thus the pop-up window appears to dynamically move out of the way of continued user foreground activity.

In the present embodiment, pop-up interface 220 provides a user interface for the control of pop-up windows. In some embodiments, the pop-up interface 220 may permit the user to specify the time interval during which user input prevents the grant of focus to pop-up windows. In alternative embodiments, the delay may be a fixed interval, such as ten seconds. In some embodiments, the pop-up interface 220 may permit the user to disable the focus-denying mechanism. In some embodiments in which the user specifies a time interval, the user may specify a value of 0. The value of 0 may signify an allowance for pop-up windows to receive focus. A user may grant focus to, e.g., pop-up windows generated by an instant messaging application, for example, when the user is waiting for an instant message.

In other embodiments, the pop-up interface 220 may provide an alternative mechanism for allowing pop-up windows to receive focus. In some of these embodiments, for instance, the user may enter a specific key combination to disable the pop-up controlling mechanism. For embodiments in which the pop-up controller provides an interface, other key combinations may perform other functions. A key combination may, for example, delete a newly-displayed pop-up window.

In further embodiments, the pop-up interface 220 may display a signal, such as a flashing light, when a pop-up window has been denied focus. In other embodiments, a sound may alert the user to the denial of focus. In some embodiments, the pop-up interface 220 may permit a user to specify a class of programs to be exempt from the denial of focus. A user may choose, for example, to permit pop-up windows issued by certain programs which warn the user of serious system problems to always be granted focus when requested. In alternative embodiments, the pop-up controller may not provide an interface region. In some embodiments, the user may use key combinations to customize the operation of the pop-up controller.

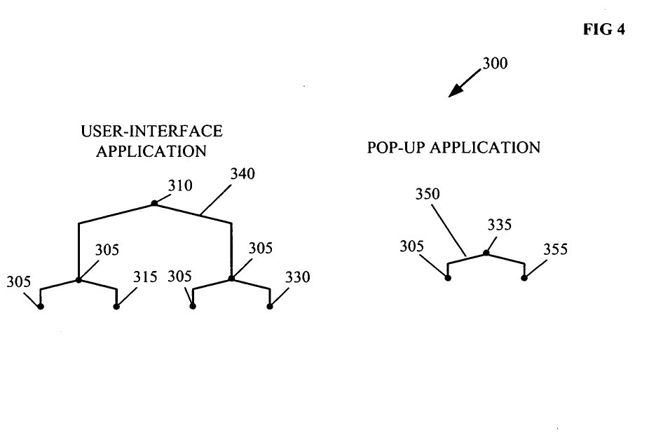

FIG. 4 depicts an example diagram of applications which are requesting focus for newly-created windows. Applications 300 include application 340 to which a user is entering input and application 350 which is generating a pop-up window. Each application 340, 350 has a main process (310 and 335 respectively) and multiple threads 305, 315, 330, 335, 355. In FIG. 4, a user may be entering input received by a window with focus created by thread 315. Thread 355 of application 350 may generate a pop-up window which requests focus. Thread 330, associated with application 340, the application the user is working with (foreground application), may also request a new window (window 330). The request may occur within a short time of user activity with respect to application 340, such as, for example, 100 ms. In these circumstances, a pop-up controller such as an operating system or other program or hardware may determine that window 330 was user initiated because of user activity in the application 340 that generated window 330 within a short time of the creation of window 330. The pop-up controller may then grant focus to window 330. Conversely, the pop-up controller may determine that the pop-up window is indeed a pop-up window because application 350 is not a foreground application. The pop-up controller may deny focus to the pop-up window.

In other embodiments, the pop-up controller may require applications to register user commands for creating new windows. The pop-up controller may then examine the input, if any, to an application to determine whether a user has initiated the creation of a new window. In alternative embodiments, an operating system may add a Boolean parameter to a function requesting focus which indicates whether the window requesting focus is a pop-up window or is user-initiated. The pop-up controller may then grant focus to a window when the request for focus indicates that the window is not a pop-up window.

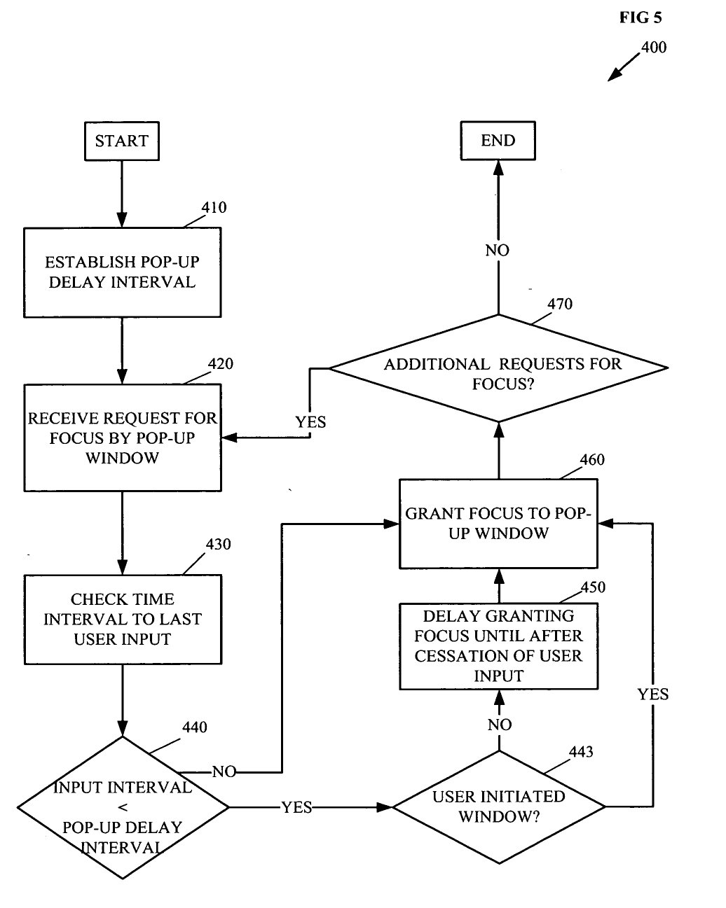

Referring now to FIG. 5, there is shown a flowchart of an embodiment to control pop-up windows. Flow chart 400 begins with establishing an interval for delaying the grant of focus to pop-up windows (element 410). A pop-up controller may deny focus to a pop-up window until there has been no input from a user for the delay interval. The user may specify a delay interval through a user interface, or the pop-up controller may adopt a fixed interval such as ten seconds. The pop-up controller may receive a request by a window for focus (element 420). For example, the pop-up controller may consist of an operating system which provides an API and the request may be in the form of a function call implemented by the API.

The pop-up controller may then check the time interval since the last input from the user (element 430). For example, the pop-up controller may continuously count down the delay interval. Whenever the pop-up controller receives a message that a user has entered input, it may reset the counter to the delay interval. The pop-up controller may then determine whether the interval since the last user interval is less than the interval for delaying the grant of focus (element 440). In the previous example, the pop-up controller may check whether the counter is at a non-zero value, which indicates that there has been user input during the pop-up delay interval. If there has been user input during the delay interval, the pop-up controller may then decide whether the request for focus was for a user-initiated window (element 443). For example, the pop-up controller may test whether the new window was generated by the application the user was currently working on and within a short time of user input.

If the pop-up controller determines the window was not user-initiated, the pop-up controller may treat the window as a pop-up window. It may delay granting focus to the window until the user ceases input for the delay interval (element 450). In the above example of the counter, the pop-up controller may delay granting focus to the window until the counter reaches 0. The pop-up controller may, for example, display the window without focus in a region of the computer screen that does not overlap the window with focus.

The pop-up controller may grant the request for focus (element 460), if the pop-up controller determined that there had been no user input for the delay interval; if the pop-up controller determined that the window requesting focus was user-initiated; or if the grant of focus had been delayed, but there has been no user input for the delay interval. If the grant of focus to a series of pop-up windows had been delayed, the pop-up controller may grant focus to each in turn, after pausing at each window to permit user input. If there are additional requests for focus (element 470), each element of flowchart 400 from element 420 to element 460 may be repeated. Otherwise, the controlling of pop-up windows may end.

Another embodiment of the invention is implemented as a program product for controlling pop-up windows. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and arrangements to control pop-up windows. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to control pop-up windows, the method comprising:
determining a pop-up delay interval;
receiving a request to grant focus to a pop-up window;
detecting input from a user within the pop-up delay interval; and
denying the request to grant focus in response to detecting user input within the pop-up delay interval.

2. The method of claim 1, further comprising granting focus to the pop-up window after the user ceases input activity for the pop-up delay interval.

3. The method of claim 1, further comprising notifying the user that a pop-up window has been denied focus.

4. The method of claim 1, further comprising:
receiving from the user a specification of classes of pop-up windows to be exempt from the denial of focus;
receiving a request to grant focus to another pop-up window;
determining that at least one of the classes in the specification of classes received from the user includes the other pop-up window; and
granting focus to the other pop-up window.

5. The method of claim 1, further comprising:
receiving from the user a command to allow pop-up windows;
receiving a request to grant focus to another pop-up window; and
granting focus to the other pop-up window.

6. The method of claim 1, further comprising:
receiving a request to grant focus to another window;
determining that the window is user initiated; and
granting focus to the window.

7. The method of claim 1, wherein denying the request to grant focus comprises displaying the pop-up window without focus.

8. The method of claim 7, wherein displaying the pop-up window without focus comprises modifying the region for the display of the pop-window.

9. An apparatus to control pop-up windows, the apparatus comprising:
a pop-up interface to detect input from a user through an input device within a pop-up delay interval; and
a pop-up displayer to deny a request to grant focus to a pop-up window upon detection of the input.

10. The apparatus of claim 9, further comprising a user interface.

11. The apparatus of claim 10, wherein the user interface is adapted to receive from the user a specification of the pop-up delay interval.

12. The apparatus of claim 10, wherein the user interface comprises user alerts to notify the user of denial of a request to grant focus to a pop-up window.

13. The apparatus of claim 9, wherein the pop-up displayer is adapted to exempt a class of pop-up windows from denial of focus.

14. The apparatus of claim 9, wherein the pop-up displayer comprises a focus grantor to permit the grant of focus to a class of pop-up windows.

15. The apparatus of claim 9, wherein the pop-up controller comprises a focus denier to deny focus to the pop-up window.

16. A machine-accessible medium containing instructions to control pop-up windows which, when the instructions are executed by a machine, cause said machine to perform operations, comprising:
determining a pop-up delay interval;
receiving a request to grant focus to a pop-up window;
detecting input from a user within the pop-up delay interval; and
denying the request to grant focus in response to detecting user input within the pop-up delay interval.

17. The machine-accessible medium of claim 16, wherein the operations further comprise:
granting focus to the pop-up window after the user ceases input activity for the pop-up delay interval.

18. The machine-accessible medium of claim 16, wherein the operations further comprise:
notifying the user that a pop-up window has been denied focus.

19. The machine-accessible medium of claim 16, wherein the operations further comprise:
displaying the pop-up window without focus.

20. The machine-accessible medium of claim 16, wherein the operations further comprise:
modifying the region for the display of the pop-up window.
